(19) United States
(12) Patent Application Publication
(10) Pub. No.: US 2006/0088267 A1
(43) Pub. Date: Apr. 27, 2006

(54) Production method of optical waveguide device and optical waveguide device

(75) Inventors: Chie Fukuda, Yokohama-shi (JP); Katsuyoshi Akiba, Yokohama-shi (JP); Kouji Shiotsuka, Yokohama-shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: Sumitomo Electric Industries, Ltd., Osaka-shi (JP)

(21) Appl. No.: 11/242,063

(22) Filed: Oct. 4, 2005

(30) Foreign Application Priority Data
Oct. 21, 2004 (JP) 2004-307270

(51) Int. Cl. G02B 6/10

(52) U.S. Cl. 385/132

(57) ABSTRACT

An optical waveguide device and a method of making the same that render excellent transmission loss characteristics and allow a large degree of freedom in circuit design are provided. The method has the steps of forming a fluorine-added silica glass first cladding layer on a substrate, forming a silica glass protective layer on the first cladding layer, annealing, forming a groove that penetrates through the protective layer and reaches the first cladding layer, forming a silica glass core in the groove, and forming a fluorine-added silica glass second cladding layer on the protective layer and the core. The device has a substrate, a first cladding layer formed on the substrate, a protective layer formed on the first cladding layer, a core formed in a groove that penetrates through the protective layer and reaches the first cladding layer, and a second cladding layer formed on the protective layer and the core.

### BACKGROUND OF THE INVENTION

1. Field of the Invention

The present invention relates to a production method of an optical waveguide device, as well as an optical waveguide device.

2. Description of the Background Arts

Fluorine-added silica glass is known to have a lower refractive index than silica glass to which no fluorine has been added. Japanese Patent Application Publication No. 9-243846 discloses a production method of an optical waveguide device having a cladding layer made of fluorine-added silica glass. In this production method, an upper cladding layer is formed by plasma CVD so as to cover a lower cladding layer as well as a core, which has a rectangular cross sectional shape and is formed on a flat surface of the lower cladding layer.

### SUMMARY OF THE INVENTION

An object of the present invention is to provide an optical waveguide device having excellent transmission loss characteristics and a large degree of freedom in circuit design, and to a production method thereof.

To achieve the object, a production method of an optical waveguide device is provided, which includes a step of forming on a substrate a first cladding layer made of fluorine-added silica glass, a step of forming a first protective layer made of silica glass on the first cladding layer, a step of annealing the first cladding layer and the first protective layer, a step of forming a groove that penetrates through the first protective layer and reaches the first cladding layer, a step of forming a core made of silica glass in the groove, and a step of forming a second cladding layer made of fluorine-added silica glass on the first protective layer and the core.

Another aspect of the present invention provides an optical waveguide device having a substrate, a first cladding layer made of fluorine-added silica glass and formed on the substrate, a first protective layer made of silica glass and formed on the first cladding layer, a core made of silica glass formed in a groove that penetrates through the first protective layer and reaches the first cladding layer, and a second cladding layer made of fluorine-added silica glass and formed on the first protective layer and the core.

### BRIEF DESCRIPTION OF THE DRAWINGS

These and other features, aspects, and advantages of the present invention will become better understood with regard to the following description, appended claims, and accompanying drawings where:

FIG. 1 is a cross-sectional view of an embodiment of the optical waveguide device according to the invention;

FIG. 2 is a flowchart describing an embodiment of the production method of the optical waveguide device according to the invention;

FIGS. 3A to 3H are diagrams showing the steps of the embodiment of the production method of an optical waveguide device according to the invention, wherein FIG. 3A shows the step of forming the first cladding layer, FIG. 3B shows the step of forming the first protective layer and the first annealing step, FIG. 3C shows the step of forming grooves, FIG. 3D shows the step of forming the core and the step of annealing the core, FIG. 3E shows the dry etching step (before etching), FIG. 3F shows the dry etching step (after etching), FIG. 3G shows the step of forming the second cladding layer, and FIG. 3H shows the step of forming the second protective layer and the second annealing step;

FIG. 4 is a conceptual diagram of an inductively coupled plasma CVD device; and

FIG. 5 is a graph showing the relationship between the power supplied to the electrode on which the substrate is mounted and the relative refractive index difference Δ of the cladding layer.

### DETAILED DESCRIPTION OF THE INVENTION

The present inventors have conceived the following as a result of a study. In the method disclosed in Japanese Patent Application Publication No. 9-243846, when power is supplied, in order to cover the core with an upper cladding layer, with the required magnitude to an electrode plate on which the substrate is mounted, the fluorine contained in the raw material gas reacts with the silica glass and is consumed. As a result, the concentration of fluorine in the formed upper cladding layer becomes lower than the desired concentration, and the degree of freedom in designing light wave circuits is compromised. Furthermore, the cladding layer made of fluorine-added silica glass becomes clouded during the annealing and dry-etching steps, and the transmission loss in the optical waveguide device increases. The optical waveguide device and production method thereof disclosed below are designed to cure these drawbacks.

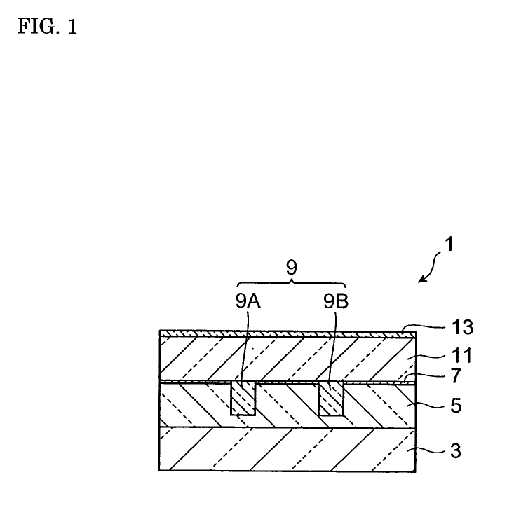

FIG. 1 is a cross-sectional view of an embodiment of the optical waveguide device according to the invention. The optical waveguide device 1 has a substrate 3, a first cladding layer 5 made of fluorine-added silica glass and formed on the substrate 3, a first protective layer 7 made of silica glass and formed on the first cladding layer 5, a core 9 made of silica glass and formed in grooves that penetrate through the first protective layer 7 and reach the first cladding layer 5, a second cladding layer 11 made of fluorine-added silica glass and formed on the first protective layer 7 and the core 9, and a second protective layer 13 made of silica glass and formed on the second cladding layer 11. It is noted here that the second protective layer 13 is not essential in the present invention.

The first protective layer 7, the second protective layer 13, and the core 9 are made of silica glass containing no additives (pure silica glass). Since fluorine-added silica glass has a lower refractive index than pure silica glass, the refractive indices of the first cladding layer 5 and the second cladding layer 11 are lower than the refractive index of the core 9. Furthermore, the relative refractive index difference Δ₁=(n₁²−n₀²)/2n₀² (where n₀ is the refractive index of pure silica glass) of the first cladding layer 5 (refractive index n₁) is preferably −0.45% or less, and the relative refractive index difference Δ₂=(n₂²−n₀²)/2n₀² of the second cladding layer 11 (refractive index n₂) is preferably −0.45% or less. Since the light can be confined in the core more effectively in this manner, the radius of curvature of the light wave circuits in the optical waveguide device can be reduced, and the degree of freedom in designing light wave circuits can be increased.

Also, although in the embodiments, pure silica glass was used as the material for the core 9, but as long as a refractive index of the core can be set to a prescribed value relative to that of the cladding, silica glass containing additives for adjusting the refractive index may also be used for the core 9.

The thickness of the first protective layer 7 is preferably less than the thickness of the core 9, and is preferably 1 μm or less. Since the refractive indices of the first protective layer 7 and the core 9 are substantially equal, it is possible to reduce the transmission loss, which occurs due to light leaking from the core 9 to the first protective layer 7, by either making the surface area of the core 9 that is in contact with the first protective layer 7 small relative to the surface area of the core 9 that is in contact with the first cladding layer 5, or by making the thickness of the first protective layer 7 1 μm or less.

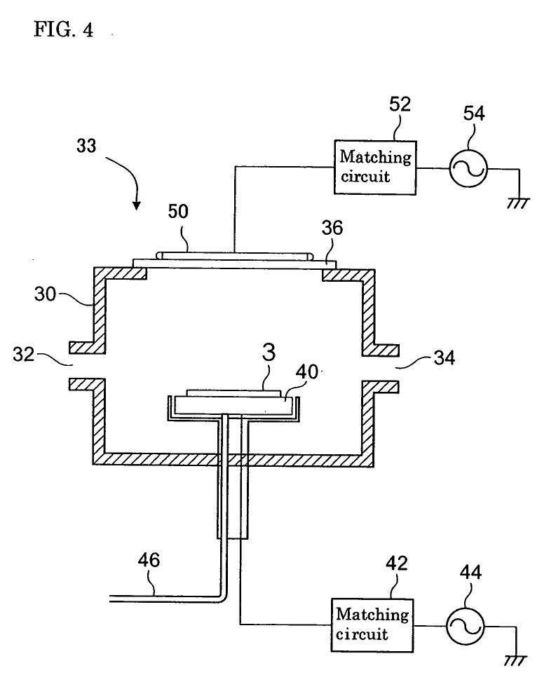

Next, an inductively coupled plasma CVD device, which is advantageous for manufacturing an optical waveguide device 1, will now be described. FIG. 4 is a conceptual diagram of the inductively coupled plasma CVD device. The inductively coupled plasma CVD device 33 has a vacuum container 30, an electrode plate 40, and a coil 50. The vacuum container 30 has an intake port 32 for taking in mixed gas, an exhaust port 34 for exhausting the mixed gas, and a high frequency inlet 36 for transmitting into the container 30 a high frequency electromagnetic field emitted from the coil 50. A high frequency power source 54 is connected to the coil 50 via a matching circuit 52. The electrode plate 40 on which a substrate is mounted is connected to a regulating high frequency power source 44 via the matching circuit 42, and is also connected to a coolant circulation pipe 46. The power supplied to the electrode plate 40 can be regulated by adjusting the regulating high frequency power source 44.

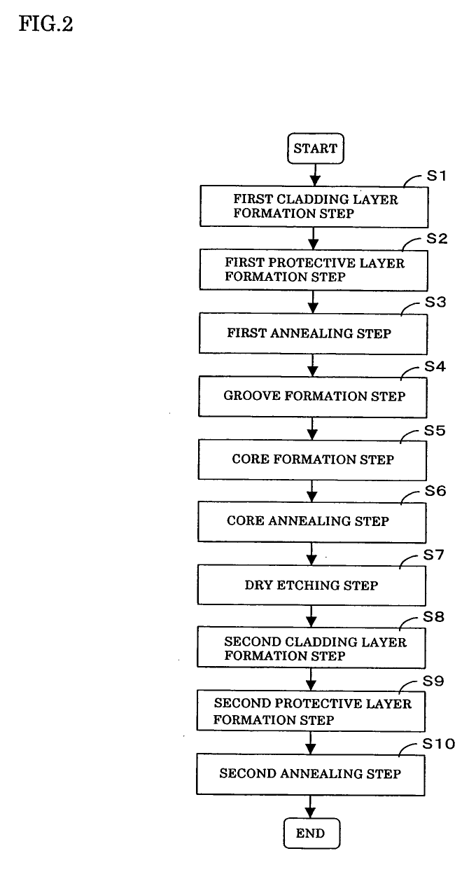

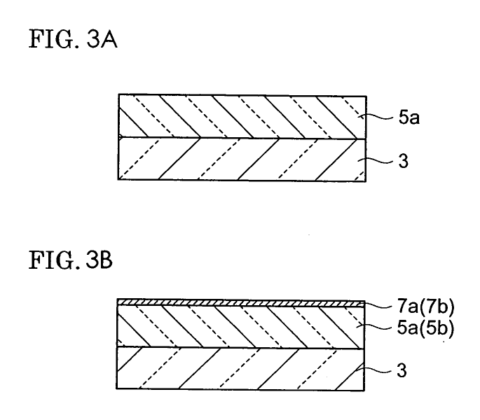

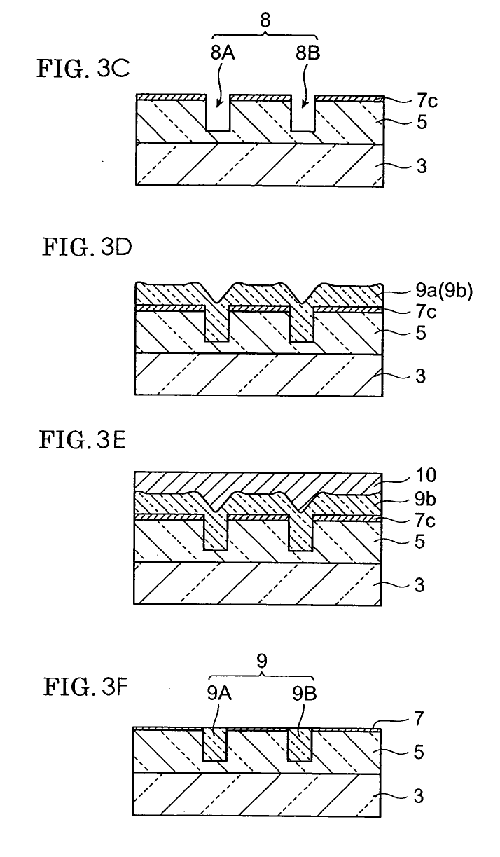

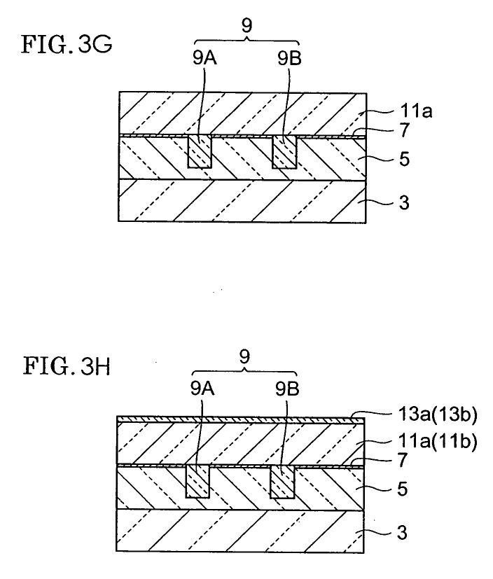

The production method of an optical waveguide device 1 will now be described. FIG. 2 is a flowchart describing an embodiment of the production method of the optical waveguide device according to the invention. FIGS. 3A to 3H are diagrams showing the embodiment of the steps in the production method of an optical waveguide device according to the invention

First, the step (S1) of forming the first cladding layer is carried out. In the step (S1) of forming the first cladding layer, the first cladding layer 5a is formed on the substrate 3 (FIG. 3A). A silica glass substrate, for example, can be used as the substrate 3. The first cladding layer 5a is made of fluorine-added silica glass. The first cladding layer 5a has a lower refractive index than pure silica glass.

In the step of forming the first cladding layer, it is preferable to form the first cladding layer 5a by introducing mixed gas of an organosilicon compound, oxygen, and fluorinated carbon (CF₄) to the vacuum container 30, and conducting the inductively coupled plasma CVD method. Favorable conditions under which the first cladding layer 5a is formed using an inductively coupled plasma CVD device 33 are: a power of 1,000 W and a high frequency of 13.56 MHz being applied to the coil 50; a power of 200 W and a high frequency of 140 kHz being applied to electrode plate 40; a pressure in the vacuum container 30 being 1 Pa; a flow ratio of the components (oxygen:organic Si compound (TEOS):fluorinated carbon (CF₄)) in the mixed gas being 70:1:10; a heating temperature of the substrate 3 being 400° C.; and a thickness of the first cladding layer 5a to be formed being 30 μm, for example.

The step (S2) of forming the first protective layer is carried out next. In the step (S2) of forming the first protective layer, a first protective layer 7a is formed on the first cladding layer 5a (FIG. 3B). The first protective layer 7a is made of pure silica glass, and the thickness of the first protective layer 7a to be formed is 2 μm, for example.

In the step of forming the first protective layer, the first protective layer 7a is preferably formed by using the inductively coupled plasma CVD method, in a state in which a mixed gas of an organosilicon compound and oxygen is introduced to the vacuum container 30 of the inductively coupled plasma CVD device. Other conditions that are favorable in the case in which the first protective layer 7a is formed using an inductively coupled plasma CVD device 33 are the same as the conditions under which the first cladding layer 5a is formed, except that the introduction of CF₄ gas should be stopped. In other words, when the step (S1) of forming the first cladding layer is completed, the introduction of CF₄ gas to the vacuum container 30 is stopped. The first protective layer 7a can be thereafter formed while maintaining the other conditions. Therefore, the production process can be simplified.

After the step (S2) of forming the first protective layer, the first annealing step (S3) is performed. In the first annealing step (S3), the first cladding layer 5a and first protective layer 7a are annealed to remove OH groups contained in the first cladding layer 5a and first protective layer 7a, so that the first cladding layer 5b and the first protective layer 7b result (FIG. 3B). Annealing is carried out for 10 hours at 1,000° C. in an oxygen atmosphere, for example.

After the first annealing step (S3), the step (S4) of forming grooves is performed. A resist mask, which is not shown in the FIG. 3C, is formed on the first protective layer 7b, and grooves 8A and 8B are formed by dry etching using C₂F₆ gas, so as to completely penetrate the first protective layer 7b and reach the first cladding layer 5b. The first protective layer 7c and the first cladding layer 5 are formed through the formation of the grooves 8A and 8B.

After the step (S4) of forming grooves, the step (S5) of forming a core is performed. In the step (S5) of forming a core, a core 9a is formed so as to fill the grooves 8a and 8b. Additionally, the core is also formed on the first protective layer 7b, which the grooves 8a and 8b are formed to penetrate (FIG. 3D). The core 9a is made of pure silica glass.

In the step of forming the core, it is preferable to form the core 9a by using the inductively coupled plasma CVD method, with the mixed gas of the starting material introduced to the vacuum container 30 of the inductively coupled plasma CVD device. Favorable conditions under which the core 9a is formed using the inductively coupled plasma CVD device 33 are: a power of 1,200 W and a high frequency of 13.56 MHz being applied to the coil 50; a power of 500 W and a high frequency of 130 kHz being applied to electrode plate 40; a pressure in the vacuum container 30 being 0.5 Pa; a flow ratio of the components (oxygen: organic Si compound (TEOS)) in the mixed gas being 20:1; and a heating temperature of the substrate 3 being 600° C. The thickness of the core 9a to be formed is 9 μm, for example.

After the step (S5) of forming a core, the step (S6) of annealing the core is performed. In the step (S6) of annealing the core, the core 9a is annealed to remove OH groups contained in the core 9a, so that the core 9b results (FIG. 3D). Annealing is carried out for 10 hours at 1,000° C. in an oxygen atmosphere, for example.

After the step (S6) of annealing the core, the dry-etching step (S7) is performed. First, a resist mask 10 is formed so as to cover the core 9b (FIG. 3E). Next, the resist mask 10, the surface layer of the core 9b, and the surface layer of the first protective layer 7c are dry etched one by one. Dry etching is carried out so as to remove the step between the core 9b and the first protective layer 7c while leaving the core 9b in the groove 8. As a result, the core 9A, core 9B, and the first protective layer 7 with a prescribed thickness remain (FIG. 3F). The thickness of the first protective layer 7 is preferably 1 μm or less. The entire first protective layer 7c may be removed by dry etching. In one embodiment, the mixed gas used in dry etching is C₂F₆ and oxygen, and the mixture ratio thereof is 5:1 (C₂F₆: oxygen).

After the dry-etching step (S7), the second cladding layer formation step (S8) is performed. In the second cladding layer formation step (S8), the second cladding layer 11a is formed on the first protective layer 7 and the core 9b (FIG. 3G). The second cladding layer 11a is made of fluorine-added silica glass. The second cladding layer 11a has a lower refractive index than pure silica glass. In the second cladding layer formation step, the second cladding layer 11a is preferably formed with the inductively coupled plasma CVD method by introducing into the vacuum container 30 a mixed gas of an organosilicon compound, oxygen, and fluorine carbon (CF₄). The specific conditions are the same as the favorable conditions for forming the first cladding layer 5a.

Next, the step (S9) of forming the second protective layer 13a made of silica glass on the second cladding layer 11a is carried out (FIG. 3H). The thickness of the second protective layer 13a to be formed is 2 μm, for example. In the step of forming the second protective layer, the second protective layer 13a is preferably formed with the inductively coupled plasma CVD method by introducing a mixed gas of an organosilicon compound and oxygen into the vacuum container 30 of the inductively coupled plasma CVD device. The favorable conditions under which the second protective layer 13a is formed using the inductively coupled plasma CVD device 33 are the same as the conditions for forming the second cladding layer 11a, except that the introduction of CF₄ gas should be stopped. In other words, when the step (S8) of forming the second cladding layer is completed, the introduction of CF₄ gas is stopped. The second protective layer 13a may be thereafter formed while maintaining the other conditions. Therefore, the production process can be simplified.

After the step (S9) of forming the second cladding layer, the second annealing step (S10) of annealing the second cladding layer 11a and the second protective layer 13a is carried out. In the second annealing step (S10), OH groups contained in the second cladding layer 11a and the second protective layer 13a are removed, so that a second cladding layer 11b and a second protective layer 13b result (FIG. 3H). The annealing is carried out for 10 hours at 1,000° C. in an oxygen atmosphere, for example.

The above steps yield an optical waveguide device 1 having a first cladding layer 5 made of fluorine-added silica glass, a first protective layer 7 made of pure silica glass, a core 9 made of pure silica glass formed in grooves that penetrate through the first protective layer 7 and reach the first cladding layer 5, a second cladding layer 11 made of fluorine-added silica glass, and a second protective layer 13 made of pure silica glass.

The effects of forming the core 9 in the grooves 8 in the production method of an optical waveguide device will be described. The present inventors discovered the following as a result of a study. At the time of forming cladding layers using an inductively coupled plasma CVD device, the amount of fluorine added to the silica glass depends on the power supplied to the electrode plate 40. The relative refractive index difference Δ₁=(n₂−n₀²)/2n₀² (where n₀ is the refractive index of pure silica glass) of a cladding layer (refractive index n) made of fluorine-added silica glass is determined by the added amount of fluorine. More specifically, when the cladding layer is formed using an inductively coupled plasma CVD device, the relative refractive index difference Δ of the cladding layers to be formed depends on the power supplied to the electrode plate 40.

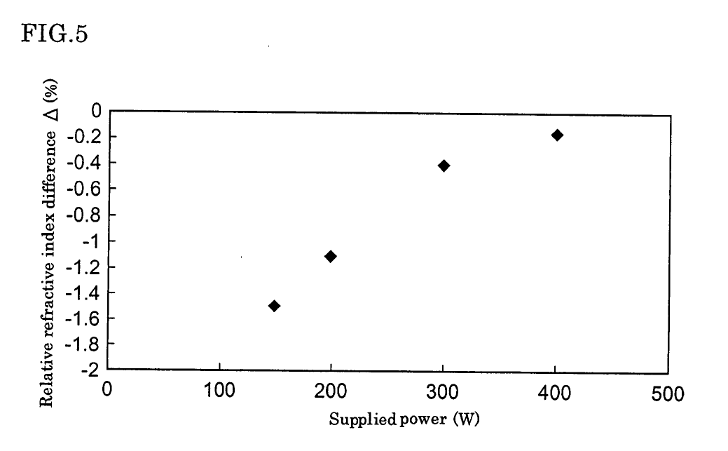

The relationship between the relative refractive index difference Δ and the power supplied to the electrode plate 40 is shown in FIG. 5. The horizontal axis in FIG. 5 shows the power supplied to the electrode plate 40, and the vertical axis shows the relative refractive index difference Δ (%) of the cladding layers. In FIG. 5, other than the power supplied to the electrode plate 40, the conditions for forming the cladding layers are the same as the favorable conditions for forming the first cladding layer 5a and the second cladding layer 11a, which are described as an embodiment of the production method of an optical waveguide device.

According to FIG. 5, when the power supplied to the electrode plate 40 increases, the absolute value of the relative refractive index difference Δ of the cladding layers is reduced. The fluorine contained in the raw material gas reacts with the formed silica glass (SiO₂) and has the effect (etching effect) of forming SiF₄. When the power supplied to the electrode plate 40 is considerable, the force with which the fluorine collides with the substrate 3 is strong. Thus, a reaction with the silica glass occurs and the amount by which the fluorine is consumed increases. As a result, it is believed that the fluorine concentration in the cladding layers decreases below the desired fluorine concentration.

When forming a second cladding layer with the inductively coupled plasma CVD method to cover the first cladding layer as well as the core that has a rectangular cross sectional shape and is formed on a flat surface of the first cladding layer 5, the power that needs to be supplied to the electrode on which the substrate-mounted in order to cover the core with a second cladding layer is about 400 W. It is apparent from FIG. 5 that when the power supplied to the electrode plate 40 is 400 W, the relative refractive index difference Δ of the cladding layers is only about −0.15%.

In the production method of an optical waveguide device of the present invention, a core is formed in the grooves, and the first protective layer and the core are fashioned into a flat, stepless state. Since the second cladding layer, in addition to the first cladding layer, is also formed on the flat surface, the power fed to the substrate-mounted electrode can be reduced in comparison with conventional practice. Thus, cladding layers to which a large amount of fluorine has been added can be obtained. In an advantageous embodiment, when a power of 200 W is supplied to the electrode on which the substrate is mounted, cladding layers can be obtained in which the relative refractive index difference Δ of the cladding layers is about −1.1%.

The effect of forming protective layers in the production method of an optical waveguide device is next described in detail. Conventionally, the first cladding layer 5a was annealed and then dry etched to form the grooves 9, in a state without a first protective layer 7a. Also, the second cladding layer 11a was annealed in a state without a second protective layer 13a. However, the present inventors discovered the following as a result of a study. When the cladding layers made of fluorine-added silica glass are annealed and dry etched, the cladding layers become clouded. When the cladding layers become clouded, the evanescent components of the guided optical waves are scattered and the transmission loss increases. The clouding of the cladding layers in the annealing and dry-etching steps can be prevented by forming protective layers made of pure silica glass on the cladding layers made of fluorine-added silica glass.

Additionally, the following has also been confirmed by the inventors. The clouding prevention effect becomes more pronounced as the thickness of the protective layers is increased. More specifically, clouding was observed in cladding layers with a relative refractive index difference Δ of −1.1% when annealing was performed after protective layers with a thickness of 1 μm were formed, but clouding was not observed in the cladding layers when annealing was performed after protective layers with a thickness of 7.5 μm were formed.

The present inventors have also confirmed the following about the above-described clouding prevention effect. The greater the absolute value of the relative refractive index difference Δ is, the more easily the cladding layers become clouded by annealing. In other words, the greater the fluorine concentration is, the more easily the cladding layers become clouded by annealing. More specifically, when the thickness of the protective layers was 1 μm, clouding was observed in the cladding layers after the annealing of the cladding layers of which a relative refractive index difference Δ of the cladding layers was −1.1%. When the thickness of the protective layers was similarly 1 μm, clouding was not observed in the cladding layers after the annealing of the cladding layers of which a relative refractive index difference Δ of the cladding layers was −0.9%.

It is preferred that the first protective layer 7 ultimately have a thickness of 1 μm or less. When the thickness of the first protective layer 7a formed in step (S2) of forming the first protective layer is 7.5 μm, twice the amount of time is required to reduce the thickness of the first protective layer to 1 μm or less by dry etching, in comparison with the case in which the thickness of the first protective layer 7a is 2 μm.

As a result of taking into account the required relative refractive index difference Δ of the first cladding layer, the clouding prevention effect of the first cladding layer, and the time required to carry out dry etching, the thickness of the first protective layer 7a formed in the step (S2) of forming the first protective layer should be preferably 2 μm or less. In this manner, the clouding prevention effect for the first cladding layer described above can thereby be obtained without having to excessively increase the production time.

The amount of fluorine addition to a cladding of the optical waveguide device 1 manufactured by the production method of an optical waveguide device of the present embodiment described above was analyzed using an electron probe microanalyzer (EPMA). As a result, the added amount of fluorine in the first cladding layer 5 and the second cladding layer 11 was −1.1% in terms of the relative refractive index difference Δ. It was thereby confirmed that a high concentration of fluorine was added to the cladding layers, and that the optical waveguide device had an excellent transmission loss, which was 0.15 dB/cm.

In accordance with the production method of an optical waveguide device of the present embodiment, the power supplied to the electrode on which the substrate is mounted does not need to be set excessively high, because the first cladding layer formation step (S1) and the second cladding layer formation step (S8) are performed on a flat surface. Thus, a cladding layer with a high concentration of fluorine can be obtained. Furthermore, clouding in the first cladding layer 5 and the second cladding layer 11 can be inhibited because the first protective layer 7a and the second protective layer 13a are formed on the first cladding layer 5a and the second cladding layer 11a, respectively, and are then annealed and etched.

While this invention has been described in connection with what is presently considered to be the most practical and preferred embodiments, the invention is not limited to the disclosed embodiments, but on the contrary, is intended to cover various modifications and equivalent arrangements included within the spirit and scope of the appended claims.

For example, although pure silica glass was used as the protective layer, it was found as a result of experimentation that the above effects can also be obtained with silica glass to which no fluorine has been added. Thus, silica glass to which no fluorine has been added can be used as the protective layer. Silica glass to which fluorine has been added up to a concentration small enough not to cause clouding may also be used.

The entire disclosure of Japanese Patent Application No. 2004-307270 filed on Oct. 21, 2004 including specification, claims, drawings, and summary are incorporated herein by reference in its entirety.

What is claimed is:

1. A production method of an optical waveguide device, comprising:
a step of forming a first cladding layer made of fluorine-added silica glass on a substrate,
a step of forming a first protective layer made of silica glass on the first cladding layer,
a step of annealing the first cladding layer and the first protective layer,
a step of forming a groove that penetrates through the first protective layer and reaches the first cladding layer,
a step of forming a core made of silica glass in the groove, and
a step of forming a second cladding layer made of fluorine-added silica glass on the first protective layer and the core.

2. The production method of an optical waveguide device according to claim 1, further comprising:
a step of forming a second protective layer made of silica glass on a second cladding layer, and
a step of annealing the second cladding layer and the second protective layer.

3. The production method of an optical waveguide device according to claim 1, wherein
in the step of forming the first cladding layer, the first cladding layer is formed with inductively coupled plasma CVD method by introducing a mixed gas of organosilicon compound, oxygen, and fluorinated carbon to a container.

4. The production method of an optical waveguide device according to claim 1, wherein
in the step of forming the second cladding layer, the second cladding layer is formed by inductively coupled plasma CVD by introducing a mixed gas of an organosilicon compound, oxygen, and fluorinated carbon to a container.

5. The production method of an optical waveguide device according to claim 1, wherein
the thickness of the first protective layer formed in the step of forming the first protective layer is 2 μm or less.

6. An optical waveguide device comprising:
a substrate;
a first cladding layer made of fluorine-added silica glass and formed on the substrate;
a first protective layer made of silica glass and formed on the first cladding layer,
a core made of silica glass formed in a groove that penetrates through the first protective layer and reaches the first cladding layer; and
a second cladding layer made of fluorine-added silica glass and formed on the first protective layer and the core.

7. The optical waveguide device according to claim 6, further comprising
a second protective layer made of silica glass and formed on the second cladding layer.

8. The optical waveguide device according to claim 6, wherein
the relative refractive index difference Δ₁ of the first cladding layer is −0.45% or less, and
the relative refractive index difference Δ₂ of the second cladding layer is −0.45% or less,
where n₀ represents the refractive index of pure silica glass, n₁ represents the refractive index of the first cladding layer, n₂ represents the refractive index of the second cladding layer, Δ₁=(n₁²−n₀²)/2n₀², and Δ₂=(n₂²−n₀²)/²n₀².

9. The optical waveguide device according to claim 7, wherein
the relative refractive index difference of Δ₁ the first cladding layer is −0.45% or less, and
the relative refractive index difference of Δ₂ the second cladding layer is −0.45% or less,
where n₀ represents the refractive index of pure silica glass, n₁ represents the refractive index of the first cladding layer, n₂ represents the refractive index of the second cladding layer, Δ₁=(n₁²−n₀²)/²n₀², and Δ₂=(n₂²−n₀²)/2n₀².

10. The optical waveguide device according to claim 6, wherein
the thickness of the first protective layer is less than the thickness of the core.

11. The optical waveguide device according to claim 6, wherein
the thickness of the first protective layer is 1 μm or less.
